(19) United States
(12) Patent Application Publication
(10) Pub. No.: US 2012/0054687 A1
(43) Pub. Date: Mar. 1, 2012

(54) DATA SEARCH RESULT DISPLAY METHOD AND DATA SEARCH RESULT DISPLAY APPARATUS

(75) Inventor: Takayuki Kawabata, Kawasaki-shi (JP)

(73) Assignee: CANON KABUSHIKI KAISHA, Tokyo (JP)

(21) Appl. No.: 13/215,906

(22) Filed: Aug. 23, 2011

(30) Foreign Application Priority Data
Aug. 26, 2010 (JP) 2010-189513
Jul. 22, 2011 (JP) 2011-161054

(51) Int. Cl. G06F 3/048

(52) U.S. Cl. 715/836

(57) ABSTRACT

A data display method includes dividing search result data according to classification and thumbnailing the search result data as a cluster of thumbnails of the search result data in a virtual three dimensional (3D) space, and displaying identification information indicating the classification of the search result data in the virtual 3D space.

### BACKGROUND OF THE INVENTION

1. Field of the Invention

The present invention relates to a search result display technique for facilitating user's selection of a desired target from a search result.

2. Description of the Related Art

The spread of the Internet has enabled users to access a massive amount of data stored in web servers all over the world. At the same time, the increase in the capacities of storage apparatuses has enabled users to store a large amount of data into even his/her individually-owned computer. Further, with the widespread use of digital cameras and mobile phones equipped with a camera, and the popularization of blogs, social networking services, Twitter, and others, the data amount has been ever increasing drastically.

In this modern society, users have become able to readily acquire an enormous amount of data, but have been finding it difficult to pick out data valuable to the user from such an enormous amount of data.

One of possible scenes where a user searches for information is a search to get knowledge about a trend. Such a search is characterized in that a user does not have a clear image about an answer that the user wants to know, and although the final goal of the search is defined as, for example, “something interesting” or “important news”, the information itself aimed by the user is extremely ambiguous.

It is effective to display a search result in an organized and classified manner, when a user makes a search to know some trend from a huge amount of data. Further, it is desirable to provide hierarchically structured organization and classification, in consideration of such a use case that a user first grasps the overall view of the search result and then looks into details of an apparently relevant part therefrom. Further, in this case, because there is no clear answer that the user wants to know, the user should view data and collect information as much as possible. In such a case, it is useful to display data as thumbnails, by which the data is displayed as reduced images, so that the user can easily view a large amount of data.

Under such circumstances, methods for organizing and classifying a search result and displaying data as thumbnail images have been developed as a method for displaying a search result for a search that a user makes to know a trend of something. For example, Japanese Patent Application Laid-Open No. 09-259130 discusses a technique for projecting search result data onto two-dimensional coordinate axes in such a manner that highly similar items are positioned close to each other, and displaying a plurality of screens in such a manner that the screens are arranged in the front-back direction of the display with the density in the information arrangement changed. A user can easily find out desired data by moving the viewpoint in a thus-constructed three-dimensional space.

Further, Japanese Patent Application Laid-Open No. 2009-110360 discusses a method for displaying images of a hierarchically classified search result. In this method, in a state that the viewpoint is zoomed out, thumbnails classified into an upper layer are displayed in such a manner that they are grouped by each cluster. Zooming in a certain cluster causes thumbnails belonging to the lower layer of that cluster to be displayed.

However, the conventional techniques are not sufficiently effective as a method for displaying a hierarchically classified search result. In particular, users should grasp the overview of a search result at an abstract higher layer, and then narrow down the information therefrom. However, the conventional techniques fail to address a display method making it easier for users to narrow down the information. For example, they are not configured to provide a sufficient display of information helpful for narrowing down the information, such as the number and names of clusters belonging to a lower layer, and the amount of data contained in the lower layer.

### SUMMARY OF THE INVENTION

According to an aspect of the present invention, a data display apparatus includes a thumbnail display unit configured to divide search result data according to classification and to display the search result data as a cluster of thumbnails of the search result data in a virtual three dimensional (3D) space, and an identification information display unit configured to display identification information indicating the classification of the search result data in the virtual 3D space.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example of a configuration of an apparatus which performs search result display processing according to an exemplary embodiment of the present invention.

FIG. 2 is a block diagram illustrating units constituting the search result display processing according to the exemplary embodiment of the present invention.

FIG. 3 is a flowchart illustrating an example of the search result display processing according to the exemplary embodiment of the present invention.

FIG. 4 illustrates an example of a hierarchically classified search result.

FIG. 5 illustrates an example of a display of the search result according to the exemplary embodiment of the present invention.

FIG. 6 illustrates an example of a cluster layout according to the exemplary embodiment of the present invention.

FIG. 7 illustrates an example of a display of cluster information according to the exemplary embodiment of the present invention.

FIG. 8 illustrates a movement of a viewpoint in a three-dimensional (3D) space according to the exemplary embodiment of the present invention.

FIG. 9 illustrates an example of a display after a cluster division according to the exemplary embodiment of the present invention.

FIG. 10 illustrates an example of timing when a cluster is divided according to the exemplary embodiment of the present invention.

FIG. 11 illustrates an example of a display of information recommendation according to the exemplary embodiment of the present invention.

### DESCRIPTION OF THE EMBODIMENTS

Various exemplary embodiments, features, and aspects of the invention will be described in detail below with reference to the drawings.

A concrete description will be given of what kind of situation a data search result display method according to an exemplary embodiment of the present invention is performed in, assuming the following example. A user is drawing up a written plan about a tour to Hokkaido, and is now looking for sightseeing spots where they will visit during the tour. For a search for information with no clear answer determined as it like this example, it is often more effective to provide a view of information in a classified and organized manner, than displaying a list of items as search result data with ranking orders assigned thereto. In such a case, the data search result display method according to the exemplary embodiment of the present invention is utilized as a method for enabling a user to make an efficient search of information.

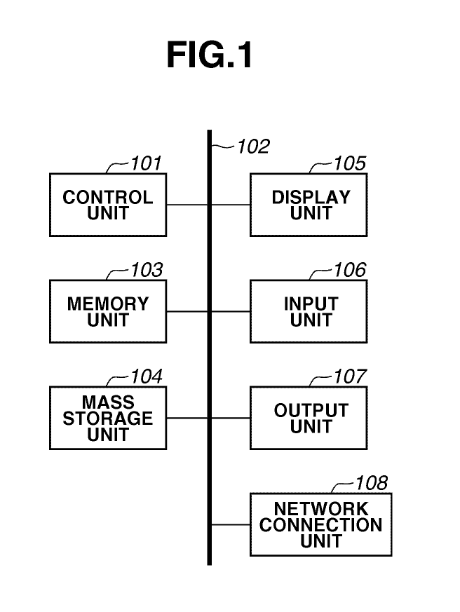

FIG. 1 illustrates an example of a configuration of an apparatus which performs search result display processing according to the exemplary embodiment of the present invention. Referring to FIG. 1, a control unit 101 includes, for example, a central processing unit (CPU). The control unit 101 is connected to a memory unit 103, a mass storage unit 104, a display unit 105, an input unit 106, an output unit 107, and a network connection unit 108 via a bus 102. The memory unit 103 is an electronic storage apparatus including, for example, a random access memory (RAM). The control unit 101 operates according to a program and data loaded onto the memory unit 103, controls the connected respective units, and inputs/outputs data. The mass storage unit 104 is a data storage apparatus such as a hard disk or an optical disk, and is used for storing, for example, an image database which will be described below. The display unit 105 is a display apparatus for graphically providing data to a user who uses the present system. The input unit 106 is a keyboard through which a user inputs a keyword to the present system, and a pointing device with which a user inputs an instruction in compliance with contents displayed on the display unit 105, such as a mouse, a stick, or a pad. The display unit 105 and the input unit 106 may be collectively embodied by an apparatus capable of serving as both units, such as a display equipped with the touch panel function. The output unit 107 is, for example, a printer device for outputting data onto paper. The network connection unit 108 is a network interface for enabling acquisition of data from the outside of the apparatus and transmission of data to the outside of the apparatus. The units 101 to 108 illustrated in FIG. 1 may be configured as a single general-purpose computer such as a personal computer (PC), or may be implemented in an electronic apparatus such as a multifunction peripheral (MFP). Alternatively, the units 101 to 108 may be constructed by a combination of a plurality of computers, a server, and peripheral devices such as a display and a personal digital assistant (PDA), which are connected to one another.

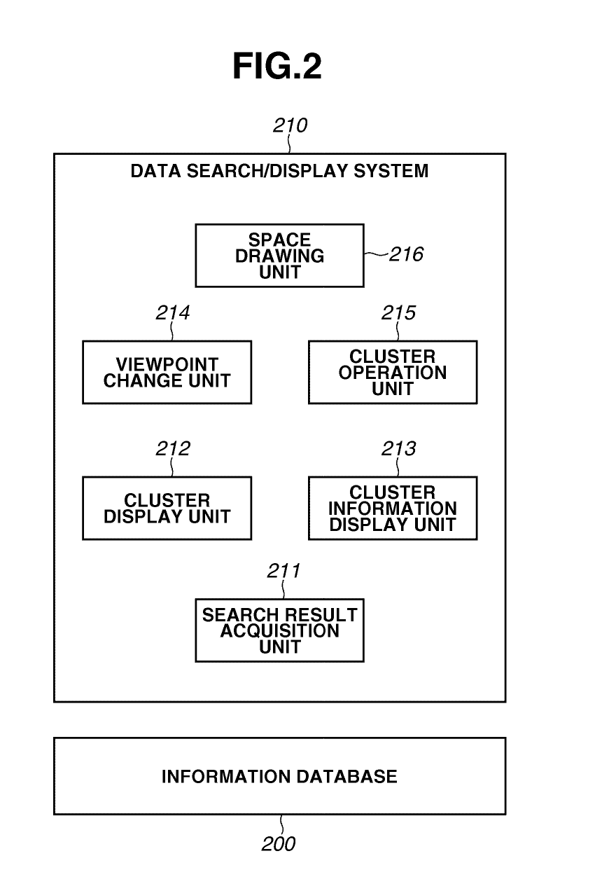

FIG. 2 is a block diagram illustrating an example of units constituting the processing performed by, for example, the PC illustrated in FIG. 1, based on the above-described assumed exemplary situation. An information database 200 and a data search/display system 210 are programs, each of which is performed by the control unit 101 illustrated in FIG. 1 in cooperation with the respective units 102 to 108.

The information database 200 operates as a service program providing functions, which will be described below, to, for example, the applications of the data search/display system 210. The information handled by the information database 200 is multimedia data including documents, images, moving images, and audio data. Upon registration of multimedia data, the information database 200 assigns an index to the data, and then stores it into the mass storage unit 104 illustrated in FIG. 1. Further, the data is hierarchically clustered, and upon input of a search query, the information database 200 functions to extract the corresponding cluster, and return cluster information and a list of data indices while holding the hierarchal structure. The cluster information includes, for example, the name of a cluster, the cluster identifier (ID) of a parent item, and the cluster ID of a child item. In the present exemplary embodiment, the data is hierarchically clustered in advance. However, each time a search is instructed, the hierarchical clustering structure may be generated by applying the hierarchical clustering method to the search result set. The detailed internal structure of the information database 200 will not be especially described herein, because it is digressional from the essence of the present invention.

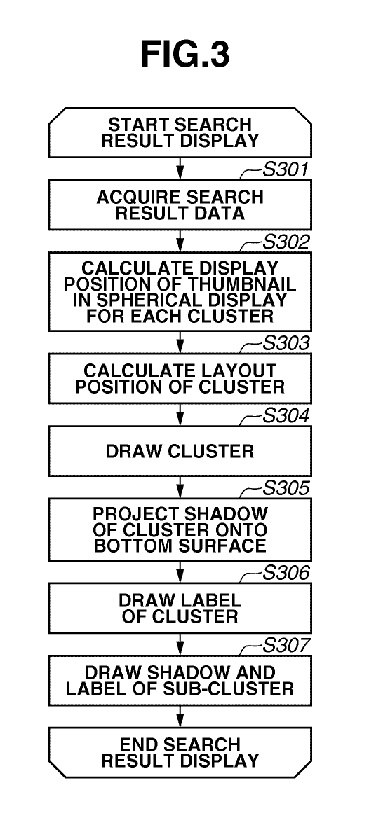

The data search/display system 210 is an embodiment of the data search result display method according to the present exemplary embodiment of the present invention. The processing performed by the data search/display system 210 is to search the information database 200 for relevant multimedia data based on a user's search request to provide the result thereof to the user, and to facilitate the user's retrieval of desired information from that result. It is effective to provide a search result under a classified and hierarchical structure so that a user can effectively search for information from a large amount of information. The data search/display system 210 is characterized by its function of displaying such a search result in a virtual three dimensional (3D) space in an intuitively and easily understood manner. This function uses the units 211 to 216, the contents of which will be described below along with a description of the processing according to the flowchart illustrated in FIG. 3.

Next, a concrete example of the processing of the data search/display system 210 will be described according to the flowchart illustrated in FIG. 3. The flowchart of FIG. 3 illustrates the steps from a reception of a search query from a user until generation of an initial display screen where a search result is provided to the user. The present exemplary embodiment will be described based on an example in which a user is drawing up a written tour plan, and sets “HOKKAIDO”, which will be a destination of the tour, and “SIGHTSEEING SPOT” as a search query to decide the content of the tour.

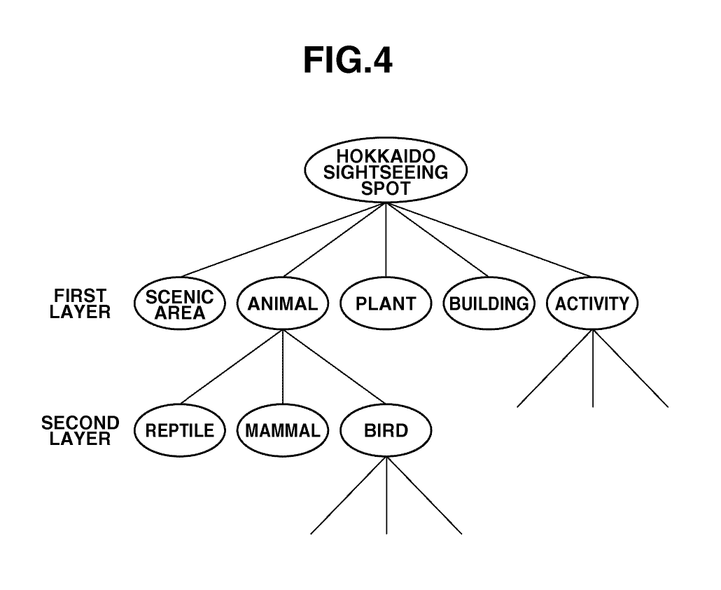

In step S301, a search result acquisition unit 211 acquires a search result set from the information database 200 based on the query input by the user. The data search/display system 210 is effective in providing a display of classified data and hierarchical data, but displaying hierarchical data is not necessarily an integral feature of the present exemplary embodiment. In the present exemplary embodiment, it is assumed that the search result acquisition unit 211 acquires a hierarchical clustering structure as illustrated in FIG. 4, as a search result. The top circle indicates “HOKKAIDO SIGHTSEEING SPOT”, which is the search query, and leads to a tree structure including circles indicating the names (labels) of clusters. For example, in FIG. 4, the highest clusters are “SCENIC AREA”, “ANIMAL”, “PLANT”, “BUILDING”, and “ACTIVITY”, each of which further has sub-clusters hanging therefrom.

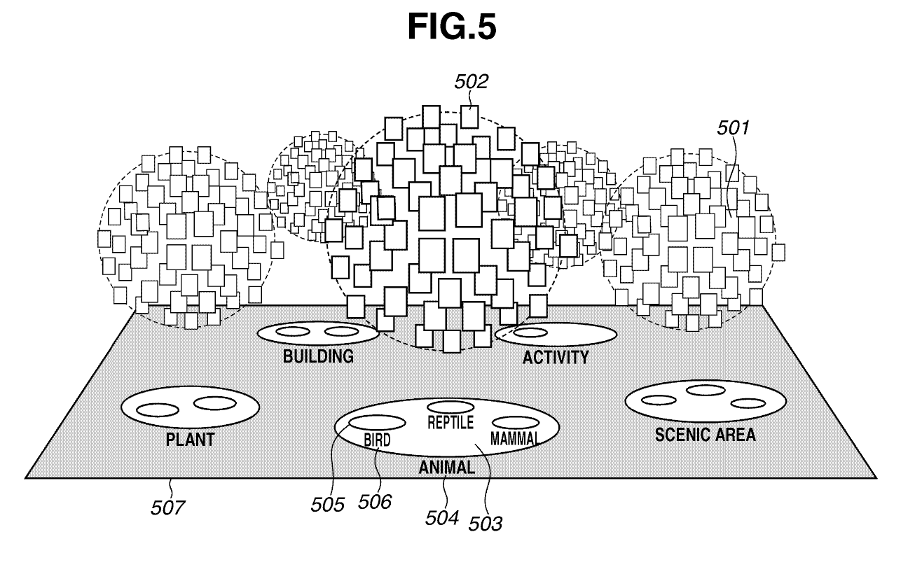

Before the description of step S302 and the subsequent steps, a description will be given of an example of an initial display screen showing a search result of the data search/display system 210 according to the present exemplary embodiment, with reference to FIG. 5. As understood from the illustration of FIG. 5, the data search/display system 210 displays, as the search result, data clustered into “SCENIC AREA”, “ANIMAL”, “PLANT”, “BUILDING”, and “ACTIVITY” in a 3D space as spherical masses 501 constituted by thumbnails 502 of that data. The thumbnail is information showing data in a reduced state or providing a representative indication of data so as to enable identification of that data, such as an image thumbnail and a document thumbnail.

In step S302, a cluster display unit 212 calculates, for each cluster, where thumbnails of data belonging to that cluster are displayed in a sphere. There are various possible methods for calculating these positions, and any method may be employed therefor. It is desirable that the thumbnails are positioned in such a manner that the individual thumbnails are displayed without overlapping each other, in consideration that a user will view the search result. In the present exemplary embodiment, the thumbnails are displayed only on the surface of the sphere, but may be also displayed inside the sphere. Further, in the present exemplary embodiment, the thumbnails have the same size, and the positions thereof are calculated so that the respective thumbnails are spaced at regular intervals, whereby the radius of the sphere varies depending on the number of data pieces belonging to the cluster. Therefore, a user can intuitively grasp the amount of data contained in each cluster. Further, it is desirable that the thumbnails of data pieces having a high degree of similarity to each other are positioned close to each other. This can be realized by, for example, assigning a front position of the sphere to the thumbnail of the data contained in a sub-cluster having the largest number of belonging data pieces among the sub-clusters contained in the cluster, and then disposing other sub-clusters around that sub-cluster in the order of degree of similarity to that sub-cluster from highest to lowest.

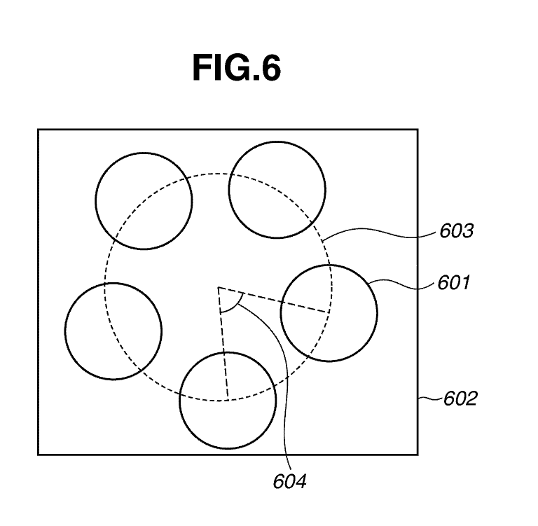

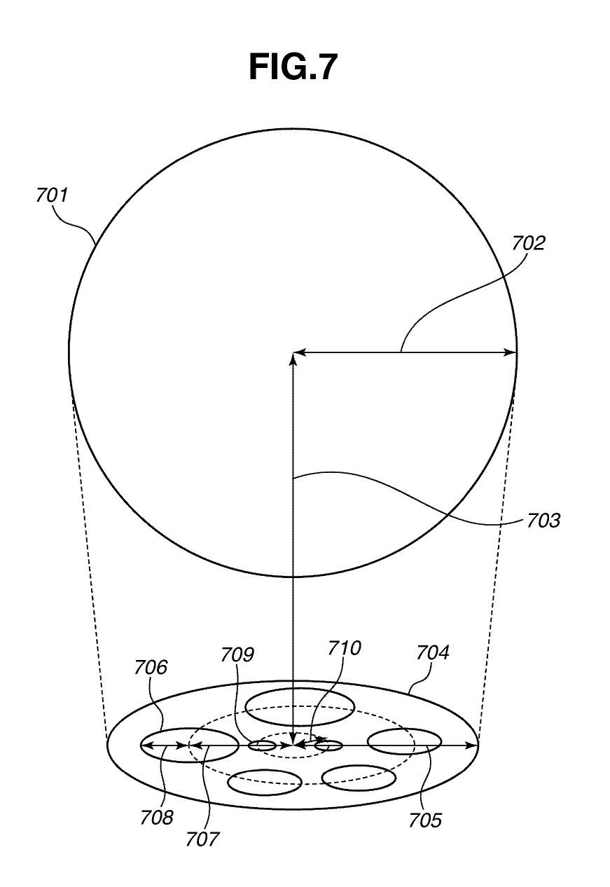

In step S303, the cluster display unit 212 calculates where the respective clusters are arranged in the 3D space. In the following, a description will be given with reference to FIGS. 6 and 7. FIG. 6 is an overhead view of the 3D space as viewed from directly above, and is used for a description of the layout positions of the clusters. Further, FIG. 7 is an enlarged view, focusing on one cluster of the clusters illustrated in FIG. 5. In the present exemplary embodiment, a temporary circle 603 is drawn on a grid-like floor 602 which is a bottom surface of the 3D space, and spheres 601 of the clusters are arranged so that the centers thereof are located on the circumference of the circle 603. The radius of the temporary circler 603 may be determined by referring to a radius 702 of a sphere 701 of the cluster calculated in step S302, and multiplying the largest radius among the clusters to be displayed by a multiplying factor α1, and adding an offset β1 thereto. Further, the interval between the spheres 601 of the respective clusters on the circumference may be determined by setting an angle of “360 degrees/the number of the clusters” as a central angle 604 so that the spheres 601 are equiangularly positioned along the circumference. However, this does not limit the present exemplary embodiment at all, and the spheres 601 of the clusters may be non-equiangularly positioned. Further, a height 703 of the center of the sphere of each cluster from the floor may be calculated based on the largest diameter among the clusters to be displayed in a similar manner to the calculation of the radius of the temporary circle 603 for determining the layout positions of the clusters. However, the method for calculating the height 703 is not limited thereto, as is the case with the above-described calculation.

In step S304, first, a space drawing unit 216 draws a grid-like floor 507, which serves as the bottom surface of the space. Above the floor 507, the cluster display unit 212 draws the clusters of the search result as the spherical masses 501 constituted by the thumbnails 502 of the data pieces belonging to that cluster, based on the position calculation results obtained in steps S302 and S303. At this time, it is possible to prevent overlaps among the thumbnails from creating poor visibility by vertically randomly swaying the respective thumbnails. The thumbnails may be swayed not only vertically but also from side to side, in every direction, or in any manner. Further, the spheres of the clusters may rotate by themselves, or may orbit around the center of the circle along which the group of cluster spheres (the group of clusters) is arranged. Alternatively, the cluster spheres may perform both this rotational motion and this orbital motion. These motions enable a user to unfailingly view all thumbnails in a predetermined time.

In step S305, a cluster information display unit 213 projects a shadow 503 of the cluster sphere on the grid-like floor 507 drawn in step S304. How to display the shadow will be now described with reference to FIG. 7. The center of the shadow 704 of the cluster sphere 701 is set right below the center of the cluster sphere 701. A radius 705 of the shadow may be determined by multiplying the radius 702 of that cluster by a multiplying factor α2, and then adding an offset 132 thereto. Further, the radius 705 of the shadow may be set so as to be proportional to the radius 702 of the cluster sphere 701.

In step S306, the cluster information display unit 213 displays a label 504 of the cluster on the circumference of the shadow 503 of the cluster sphere 701.

In step S307, the cluster information display unit 213 displays the information of the sub-clusters of the cluster as shadows 505 and labels 506 in such a manner that the shadows 505 and the labels 506 are contained in the shadow 503 of the cluster sphere 701 drawn in step S305. How to display the sub-cluster information will be now described with reference to FIG. 7. A radius 708 of the shadow of the sub-cluster may be calculated by an equation proportional to the number of data pieces belonging to that sub-cluster in a similar manner to the above-described calculation. This method enables a user to intuitively understand and compare the information amount of each sub-cluster from the size of the shadow 706 of the sub-cluster. The shadows 706 of the sub-clusters are disposed on the circumference of a circle concentric with the shadow 704 of the cluster. A radius 707 of this concentric circle can be calculated by multiplying the radius 705 of the shadow of the cluster by a multiplying factor α3 and then adding an offset β3 thereto.

Further, the interval between the shadows 706 of the respective sub-clusters on the circumference is determined so that they are equiangularly positioned along the circumference in a similar manner to the calculation for determining the cluster layout performed in step S303. However, this does not limit the present exemplary embodiment at all, and the shadows 706 of the sub-clusters may be non-equiangularly positioned. For example, the shadows 706 of the sub-clusters may be positioned so that they are located below the mass of the thumbnails of the data pieces contained in that sub-cluster. Further, the cluster information display unit 213 displays the label 506 of the sub-cluster in a vertically erected manner on the circumference of the shadow 706 of the sub-cluster. These displays of the shadows and the labels of the sub-clusters, especially when there are a large number of sub-clusters, may lead to an untidy appearance, thereby discouraging a user to understand the information on the contrary. Therefore, the top M sub-clusters having the largest number of belonging data pieces among the sub-clusters may be displayed according to the above-described display method, and the remaining sub-clusters may be displayed in an abbreviated manner like a shadow 709 illustrated in FIG. 7.

In the abbreviated display, the sub-cluster is displayed as only an appropriately reduced shadow. The shadow 709 displayed in the abbreviated manner is disposed at the inner side of the circle where the shadows of the top M sub-clusters are disposed, and on the circumference of a circle having a radius 710 calculated by multiplying the radius of the circle where the shadows of the top M sub-clusters are disposed by a multiplying factor α4 and then adding an offset β4 thereto. In this way, the sub-clusters of a cluster are displayed within the shadow of that cluster as the shadows and the labels, and the size of the shadow is set to become proportional to the number of data pieces belonging to that sub-cluster. As a result, a user can intuitively understand the hierarchical classification of the search result. Further, the position of the shadow and label of a sub-cluster may rotate according to a rotation of the cluster sphere. Especially, if the thumbnails of the cluster are grouped by each sub-cluster, and the shadow and the label of a sub-cluster are disposed below the corresponding grouped thumbnails, it is desirable that the shadow and the label of the sub-cluster rotates according to a rotation of the cluster sphere.

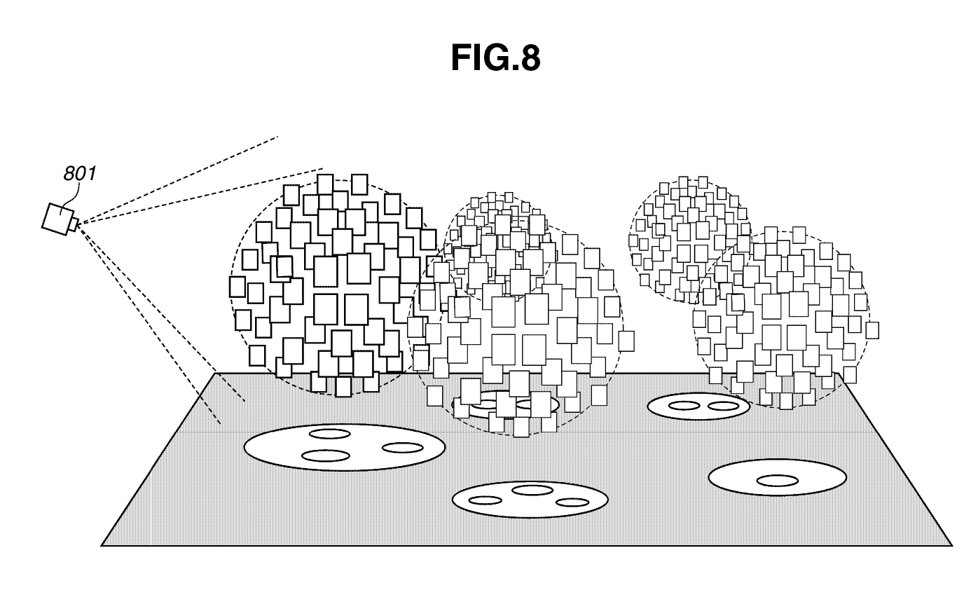

Hereinbefore, the flow until the display of the initial screen showing a search result of the data search/display system 210, and the respective component units illustrated in FIG. 2 with the exception of a few, have been described according to the flowchart illustrated in FIG. 3. Further, the data search/display system 210 includes a viewpoint 801 as illustrated in FIG. 8, and an image in the 3D space as viewed from the position of the viewpoint 801 is output to the display unit 105 such as a liquid crystal display monitor. A user can search for desired information while walking through the 3D space while freely changing the position of the viewpoint 801, the direction of eyes, and the angle of view through, for example, an input with a mouse operation. This operation corresponds to zooming-in and zooming-out processing. A viewpoint change unit 214 changes the position of the viewpoint, the direction of eyes, and the angle of view in response to a change in the user's viewpoint which is obtained via the input unit 106.

Further, while a user is making a search by walking through the 3D space, the respective display units have the function to change the display according to the position of the viewpoint so that the user can easily understand the information. For example, the cluster display unit 212 displays a thumbnail in a blurred state according to the distance between the position of the viewpoint and the thumbnail as this distance is increasing. The blurred display of a thumbnail away from the viewpoint aids in highlighting of a nearer thumbnail, facilitating a user to view the information with full attention thereto. Further, the cluster information display unit 213 moves the label 504 of the cluster and the label 506 of the sub-cluster along the circumferences of the respective shadows in a sliding manner according to the position of the viewpoint, thereby arranging the labels to face the front relative to the viewpoint at anytime.

Further, a movement of the viewpoint may be controlled by not only a manual operation through a user's input but also a semi-automatic operation which works under a predetermined rule. For example, in the present exemplary embodiment, the viewpoint change unit 214 includes a semi-automatic operation for automatically moving the viewpoint to such a position that a cluster is displayed at the front in an enlarged manner, in response to selection of the shadow 503 of that cluster by, for example, a click operation of the mouse.

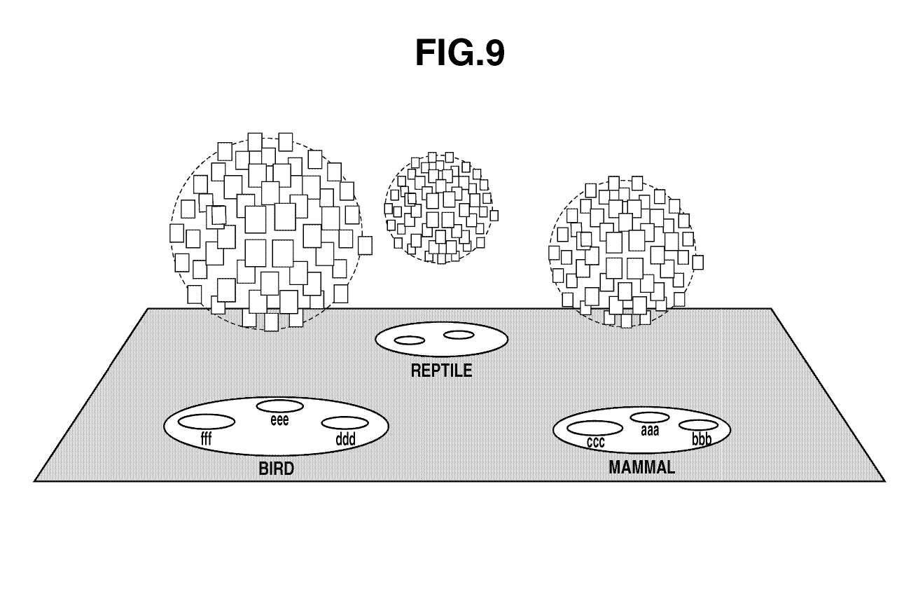

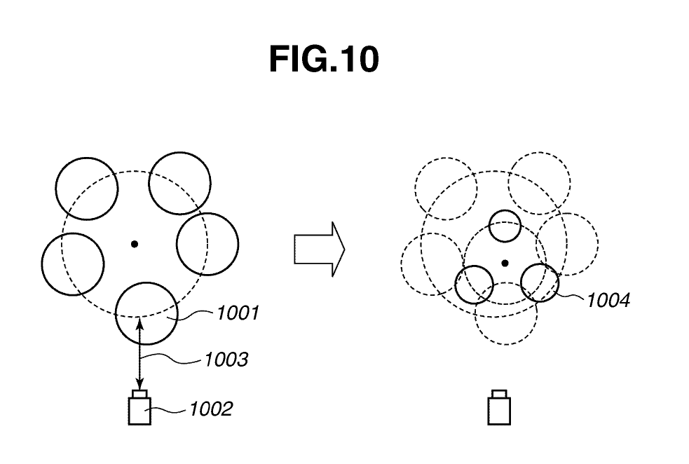

The initial display illustrated in FIG. 5 shows only the first layer in the hierarchical type classification of the search result illustrated in FIG. 4. For a search for information, it is efficient to first understand an outline of the classification of the information at an abstract upper layer, and then narrow down the information to a more concrete and lower concept therefrom. Now, a description will be given of a display method performed by the data search/display system 210 when a user is narrowing down information, with reference to FIGS. 9 and 10.

FIG. 9 illustrates an example of a display when a cluster operation unit 215 narrows down the information from the initial display illustrated in FIG. 5 to cause “BIRD”, “REPTILE”, and “MAMMAL”, which are lower clusters of the “ANIMAL” cluster, to be displayed. As illustrated in FIG. 9, compared to the initial display illustrated in FIG. 5, a difference therefrom is only the contents of the displayed clusters, and the clusters are displayed in the same manner. The display example illustrated in FIG. 9 shows only the sub-clusters in the “ANIMAL” cluster to which the information is narrowed down, but the display at this stage may show the clusters at the first layer such as “PLANT”, “BUILDING”, “SCENIC AREA”, and “ACTIVITY”, together with the clusters at the second layer. The screen during a transition from the initial screen illustrated in FIG. 5 to the screen resulting from narrowing down the information to the “ANIMAL” cluster illustrated in FIG. 9 may be effectively displayed with use of an animation indicating moving thumbnails, so that the user can intuitively recognize that the information is currently being narrowed down.

The timing when the cluster operation unit 215 narrows down the information to a lower cluster may be determined according to an explicit instruction from a user with a mouse operation. However, in the present exemplary embodiment, this timing is automatically determined based on the distance between the viewpoint and a cluster so as to realize a more intuitive expression in the 3D space. Further, this timing may be determined based on the degree of a zooming-in or zooming-out operation. More specifically, as illustrated in FIG. 10, when a distance 1003 between a viewpoint position 1002 that a user can freely operate and a cluster 1001 falls below a set threshold value, the cluster operation unit 215 operates to divide that cluster into sub-clusters. On the other hand, as an explicit instruction from a user with a mouse operation, for example, double clicking the shadow of a cluster may cause that cluster to be divided into sub-clusters. At this time, this user's operation may be combined with the above-mentioned semi-automatic operation for a viewpoint movement so that double clicking the shadow of a cluster positioned at the back in the screen causes the viewpoint to be moved to such a position that the clicked cluster is displayed at the front in an enlarged manner, and then the clicked cluster to be divided into sub-clusters. Alternatively, a user's explicit instruction may be used in coexistence with the auto determination according to the position of the viewpoint.

After that, the information can be narrowed down by dividing the cluster up to the n-th layer in the same manner.

Further, the data search/display system 210 also has the function of combining clusters and displaying a cluster of a parent layer. The display method and the timing for the combination are arranged in such a manner that the data search/display system 210 provides a display as if the data search/display system 210 performs reverse reproduction of the division of the cluster, according to the same idea as the idea for a division of a cluster.

Dividing a cluster into sub-clusters and combining clusters into a parent cluster in this way enable a user to intuitively narrow down information while walking through the 3D space.

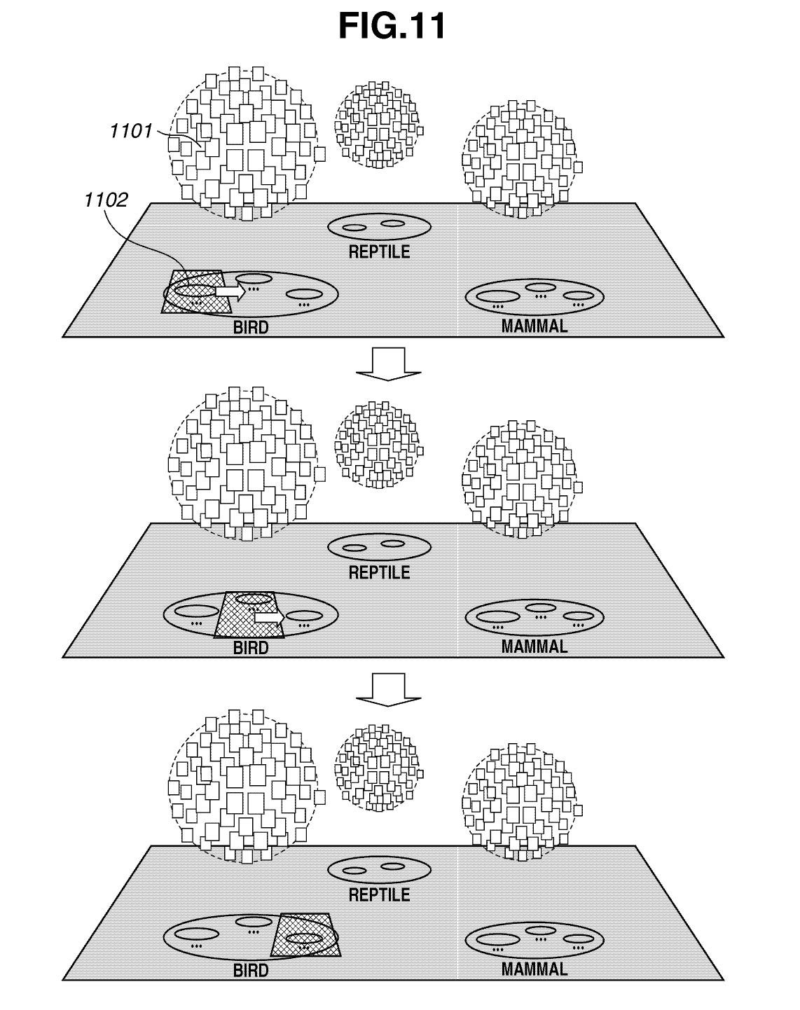

Further, the data search/display system 210 also has the display function of guiding a user to recommended information. Examples of recommended information include a cluster having the largest number of belonging data pieces among clusters that are currently being displayed, or a frequently viewed cluster that is calculated from the past history. After a not-illustrated recommended information calculation unit acquires recommended information to a user, the space drawing unit 216 highlights that cluster, as if a wave is caused from the left to the right on the grid-like floor 1102 right below the cluster 1101 containing the recommended information, as illustrated in FIG. 11. Utilizing a part constituting the 3D space in this way enables the data search/display system 210 to provide a display for notifying a user of recommended information in an intuitive and natural manner. While, in the above description, a wave is caused from the left to the right on the grid-like floor 1102 as the display method, the wave may be caused in any direction, or may be caused from the outside to a recommended cluster.

As mentioned above, in the data search result display method according to the present exemplary embodiment, it is possible to provide various user interfaces (UIs) in a 3D space, and allow a user to intuitively and efficiently search for desired information from a large amount of information.

In the above-described exemplary embodiment, a shadow is displayed on the floor below a cluster, but a displayed object here may be not a shadow. Since displaying a shadow of a cluster in a 3D space is easily understandable as a metaphor, this has been described as an example. However, a displayed object may have any shape such as a triangle shape or a rectangular shape, and further may be variously colored instead of having a single color like a shadow. The data search/display system 210 can further facilitate a user's information search by utilizing differences in shape and color to provide additional information useful for the user's search. For example, the data search/display system 210 may express a classification based on a different standpoint from the classification expressed as masses of clusters, or may highlight a cluster that the system recommends. Differences in color and shape are visually easily recognizable to users, and are suitable for expressing a classification.

It should be noted that the present exemplary embodiment can be also achieved by providing a system or an apparatus with a storage medium storing program code of software for realizing the functions of the above-described exemplary embodiment, and causing a computer (or a CPU, a micro processing unit (MPU), and/or the like) of the system or the apparatus to read out and execute the program code stored in the storage medium. In this case, the program code readout from the storage medium realizes the functions of the above-described exemplary embodiment, and therefore the storage medium storing this program code constitutes the present exemplary embodiment.

Examples of the storage medium for providing the program code include a floppy disk, a hard disk, an optical disk, a magneto-optical disk, a compact disc read only memory (CD-ROM), a compact disc recordable (CD-R), a magnetic tape, a non-volatile memory card, a read only memory (ROM), and a digital versatile disc (DVD).

Further, the present exemplary embodiment includes not only a case in that the computer executes the read-out program code to realize the functions of the above-described exemplary embodiment, but also a case that, for example, an operating system (OS), which works on a computer, performs a part or the whole of actual processing based on the instruction of the program code, and this processing realizes the functions of the above-described exemplary embodiment.

Further, the present exemplary embodiment also includes such a case that, after the program code read out from the storage medium is written in a function expansion board inserted in a computer or a memory provided to a function expansion unit connected to a computer, a CPU or the like provided to the function expansion board or the function expansion unit performs apart or the whole of actual processing according to an instruction of that program code, and this processing realizes the functions of the above-described exemplary embodiment.

According to the exemplary embodiment of the present invention, effectively displaying hierarchically classified search result data in a 3D space enables a user, who looks for ambiguous information, to efficiently retrieve optimal information.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Applications No. 2010-189513 filed Aug. 26, 2010 and No. 2011-161054 filed Jul. 22, 2011, which are hereby incorporated by reference herein in their entirety.

What is claimed is:

1. A data display apparatus comprising:
a thumbnail display unit configured to divide search result data according to classification and to display the search result data as a cluster of thumbnails of the search result data in a virtual three dimensional (3D) space; and
an identification information display unit configured to display identification information indicating the classification of the search result data in the virtual 3D space.

2. The data display apparatus according to claim 1, further comprising a drawing unit configured to draw a surface in the virtual 3D space.

3. The data display apparatus according to claim 2, wherein the drawing unit draws a shadow on the surface according to a position and a size of the cluster of thumbnails.

4. The data display apparatus according to claim 3, wherein the identification information display unit displays a classification name indicating the classification of the search result data on the drawn shadow.

5. The data display apparatus according to claim 1, wherein the classification is acquired from an attribute of the search result data.

6. The data display apparatus according to claim 1, wherein the thumbnail display unit includes a determination unit configured to determine a display position of a thumbnail included in the cluster of thumbnails of the search result data based on a sub-cluster of the search result data, the sub-cluster being more detailed than the classification.

7. The data display apparatus according to claim 2, wherein the identification information display unit displays a sub-cluster name of a sub-cluster of the search result data on the surface, the sub-cluster being included in the cluster of thumbnails of the search result data and being more detailed than the classification.

8. The data display apparatus according to claim 7, wherein the drawing unit displays a shadow on the surface at a position where the sub-cluster displayed by the thumbnail display unit and the sub-cluster name displayed by the identification information display unit correspond to each other.

9. The data display apparatus according to claim 7, wherein the identification information display unit rotates the sub-cluster name displayed on the surface according to a rotation of the sub-cluster during a rotation of the cluster of thumbnails of the search result data.

10. The data display apparatus according to claim 1, wherein the cluster of thumbnails has a spherical shape.

11. A data display apparatus comprising:
a thumbnail display unit configured to divide search result data according to classification and to display the search result data as a cluster of thumbnails of the search result data in a virtual three dimensional (3D) space;
an instruction unit configured to issue an instruction for an enlarged display of the cluster of thumbnails of the search result data; and
a cluster display control unit configured to divide the cluster of thumbnails into more detailed sub-clusters according to the instruction.

12. The data display apparatus according to claim 11, wherein the cluster display control unit divides the cluster into the sub-clusters according to a degree of enlargement by the instruction unit.

13. A data display apparatus comprising:
a thumbnail display unit configured to divide search result data according to classification and to display the search result data as a cluster of thumbnails of the search result data in a virtual three dimensional (3D) space; and
a cluster display control unit configured to divide the cluster of thumbnails into more detailed sub-clusters according to a size of the cluster of thumbnails of the search result data at a viewpoint in the virtual 3D space.

14. A data displaying method performed by a data display apparatus, the method comprising:
dividing search result data according to classification and displaying the search result data as a cluster of thumbnails of the search result data in a virtual three dimensional (3D) space; and
displaying identification information indicating the classification of the search result data in the virtual 3D space.

15. A computer-readable storage medium storing a program causing a computer to execute a method comprising:
dividing search result data according to classification and thumbnailing the search result data as a cluster of thumbnails of the search result data in a virtual three dimensional (3D) space; and
displaying identification information indicating the classification of the search result data in the virtual 3D space.
